(19) United States
(12) Patent Application Publication
(10) Pub. No.: US 2008/0129844 A1
(43) Pub. Date: Jun. 5, 2008

(54) Apparatus for image capture with automatic and manual field of interest processing with a multi-resolution camera

(76) Inventors: Francis J. Cusack, Groton, MA (US); Jonathan Cook, Los Gatos, CA (US)

Correspondence Address: HAVERSTOCK & OWENS LLP, 162 N WOLFE ROAD, SUNNYVALE, CA, 94086, US

(21) Appl. No.: 11/977,887

(22) Filed: Oct. 26, 2007

Related U.S. Application Data
(60) Provisional application No. 60/854,859, filed on Oct. 27, 2006.

(51) Int. Cl. H04N 5/217

(52) U.S. Cl. 348/241; 348/E05.078

(57) ABSTRACT

An apparatus for capturing a video image comprising a means for generating a digital video image, a means for classifying the digital video image into one or more regions of interest and a background image, and a means for encoding the digital video image, wherein the encoding is selected to provide at least one of; enhancement of the image clarity of the one or more ROI relative to the background image encoding, and decreasing the video quality of the background image relative to the one or more ROI. A feedback loop is formed by the means for classifying the digital video image using a previous video image to generate a new ROI and thus allow for tracking of targets as they move through the imager field-of-view.

### RELATED APPLICATIONS

This application is a non-provisional which claims priority under 35 U.S.C. § 119(e) of the co-pending, co-owned U.S. Provisional Patent Application Ser. No. 60/854,859 filed Oct. 27, 2006, and entitled “METHOD AND APPARATUS FOR MULTI-RESOLUTION DIGITAL PAN TILT ZOOM CAMERA WITH INTEGRAL OR DECOUPLED VIDEO ANALYTICS AND PROCESSOR.” The Provisional Patent Application Ser. No. 60/854,859 filed Oct. 27, 2006, and entitled “METHOD AND APPARATUS FOR MULTI-RESOLUTION DIGITAL PAN TILT ZOOM CAMERA WITH INTEGRAL OR DECOUPLED VIDEO ANALYTICS AND PROCESSOR” is also hereby incorporated by reference in its entirety.

### FIELD OF THE INVENTION

This invention relates to apparatuses for capturing digital video images, identifying Regions of Interest (ROI) within the video camera field-of-view, and efficiently processing the video for transmission, storage, and tracking of objects within the video. Further, the invention further relates to the control of a high-resolution imager to enhance the identification, tracking, and characterization of ROIs.

### BACKGROUND OF THE INVENTION

State-of-the-art surveillance applications require video monitoring equipment that provides a flexible field-of-view, image magnification, and the ability to track objects of interest. Typical cameras supporting these monitoring needs are referred to as Pan Tilt Zoom (PTZ) camera. A PTZ camera is typically a conventional imager fitted with a controllable zoom lens to provide the desired image magnification and mounted on a controllable gimbaled platform that can be actuated in yaw and pitch to provide the desired pan and tilt view perspectives respectively. However, there are limitations and drawbacks to gimbaled PTZ cameras. The limitations include: loss of viewing angle as a camera is zoomed on a target; the control, mechanical, and reliability issues associated with being able to pan and tilt a camera; and cost and complexity issues associated with a multi-camera gimbaled system.

The first limitation is the ability of the camera to zoom while still providing a wide surveillance coverage. Wide area coverage is achieved by selecting a short focal length, but at the expense of spatial resolution for any particular region of interest. This makes detection, classification and interrogation of targets much more difficult or altogether impossible while surveilling a wide area. Conversely, when the camera is directed and zoomed onto a target for detailed investigation, a longer focal length is employed to increase the spatial resolution and size of the viewed target. The tradeoff for optically zooming a camera for increased spatial resolution is the loss of coverage area. Thus, a conventional camera using an optical zoom does not provide wide area coverage while providing increased spacial resolution of a target area. The area of coverage is reduced as the spatial resolution is increased during zooming. Currently, there is not a single point solution that provides both wide area surveillance and high-resolution target interrogation.

There are also limitations and drawbacks associated with surveillance cameras using gimbaled pan and tilt actuations for scanning a target area or tracking a target. Extending the surveillance area beyond the field-of-view of a fixed position camera can be achieved by stewing the camera through a range of motion in pan (yaw), tilt (pitch) or both. The changing of the pan or tilt can be achieved with either a continuous motion or a step and stare motion profile where the camera is directed to discrete positions and dwells for a predetermined period before moving to the next location. While these techniques are effective at extending the area of coverage of one camera, the camera can only surveil one section of a total area of interest at any one time, and is blind to regions outside the field-of-view. For surveillance applications, this approach leaves the surveillance system vulnerable to missing events that occur when the camera field-of-view is elsewhere.

A further limitation of the current state-of-the-art surveillance cameras arises when actively tracking a target with a conventional “Pan, Tilt, and Zoom” (PTZ) camera. This configuration requires collecting target velocity data, feeding it to a tracker with predictive capability, and then converting the anticipated target location to a motion control signal to actuate the camera pan and tilt gimbals such that the imager is aligned on target for the next frame. This method presents several challenges to automated video understanding algorithms. First, a moving camera presents a different background at each frame. This unique background must then in turn be registered with previous frames. This greatly increases computational complexity and processing requirements for a tracking system. Secondly, the complexity that is intrinsic to such an opto-mechanical system, with associated motors, actuators, gimbals, bearings and such, increases the size and cost of the system. This is exacerbated when high-velocity targets are to be imaged, and will necessarily in turn control the requirements on the gimbal response time, gimbal power supply and mechanical and optical stabilization. Further, the Mean Time Between Failure (MTBF) is detrimentally impacted by the increased complexity, and number of high performance moving parts.

One conventional solution to the limitation caused by zooming a camera is to provide both a wide Field of View (FOV) and a target interrogation view by the use of extra cameras. Some of the deficiencies described previously can be addressed by using a PTZ camera to augment an array of fixed point cameras. In this configuration, the PTZ camera is used for interrogation of targets detected by the fixed camera(s). Once a target is detected, manual PTZ allows detailed manual target interrogation and classification. However, there are several limitations to this approach. First, there is no improvement to detection range since detection is achieved with fixed point cameras, presumably set to wide area coverage. Second, the PTZ channel can only interrogate one target at a time, which requires complete attention of operator, at the expense of the rest of the FOV covered by the other cameras. This leaves the area under surveillance vulnerable to events and targets not detected.

Algorithms can be employed on the PTZ video to automate the interrogation of targets. However, this solution has the disadvantage of being difficult to set up as alignment is critical between fixed and PTZ cameras. True bore-sighting is difficult to achieve in practice, and the unavoidable displacement between fixed and PTZ video views introduce viewing errors that are cumbersome to correct. Mapping each field-of-view through GPS or Look Up Tables (LUTS) is complex and lacks stability; any change to any camera location requires re-calibration, ideally to sub-pixel accuracy.

What is needed is a system that combines traditional PTZ camera functionality with sophisticated analysis and compression techniques to prioritize and optimize what is stored, tracked and transmitted over the network to the operator, while lowering the cost and improving the reliability issues associated with a multi-camera gimbaled system.

### SUMMARY OF THE INVENTION

In a first aspect of the invention, an apparatus for capturing video images is disclosed. The apparatus includes a device for generating digital video images. The digital video images can be received directly from a digital imaging device or can be a digital video image produced from an analog video stream and subsequently digitized. Further, the apparatus includes a device for the classification of the digital video images into one or more Regions of Interest (ROI) and background video image. An ROI can be a group of pixels associated with an object in motion or being monitored. The classification of ROIs can include identification and tracking of the ROIs. The identification of ROIs can be performed either manually by a human operator or automatically through computational algorithms referred to as video analytics. The identification and prioritization can be based on predefined rules or user-defined rules. Once an ROI is identified, tracking of the ROI is performed through video analytics. Also, the invention includes an apparatus or means for encoding the digital video image. The encoding can compress and scale the image. For example, an imager sensor outputs 2K by 1K pixel video stream where the encoder scales the stream to fit on a PC monitor of 640×480 pixels and compresses the stream for storage and transmission. Other sized sensors and outputs are complete. Standard digital video encoders include H.264, MPEG4, and MJPEG. Typically these video encoders operate on blocks of pixels. The encoding can allocate more bits to a block, such as an ROI, to reduce the information loss caused by encoding and thus improve the quality of the decoded blocks. If fewer bits are allocated to a compressed block, corresponding to a higher compression level, the quality of the decoded picture decreases. The blocks within the ROIs are preferably encoded with a lower level of compression providing a higher quality video within these ROIs. To balance out the increased bit rate, caused by the higher quality of encoding for the blocks within the ROIs, the blocks within the background image are encoded at a higher level of compression and thus utilize fewer bits per block.

In one embodiment of the first aspect of the invention, a feedback loop is formed. The feedback uses a previous copy of the digital video image or previous ROI track information to determine the position and size of the current ROI. For example, if a person is characterized as a target of interest, and as this person moves across the imager field-of-view, the ROI is updated to track the person. The means for classifying the video image into one or more ROIs can determine an updated ROI position using predictive techniques based on the ROI history. The ROI history can include previous position and velocity predictions. The predictive techniques can compensate for the delay of one or more video frames between the new video image and the previous video image or ROI position prediction. The ROI updating can be performed either manually, by an operator moving a joystick, or automatically using video analytics. Where multiple ROIs are identified, each ROI can be assigned a priority and encoded at a unique compression level depending on the target characterization and prioritization. Further, the encoding can change temporally. For example, if the ROI is the license plate on a car, then the license plate ROI is preferably encoded with the least information loss providing the highest video clarity. After a time period sufficient to read the license, a greater compression level can be used, thereby reducing the bit rate and saving system resources such as transmission bandwidth and storage.

In a second embodiment of the invention, the encoder is configured to produce a fixed bit rate. Fixed rate encoders are useful in systems where a fixed transmission bandwidth is allocated for a monitoring function and thus a fixed bandwidth is required. For an ROI, the encoding requires more bits for a higher quality image and thus requires a higher bit rate. To compensate for the increased bit rate for the one or more ROIs, the bit rate of the background image is reduced by an appropriate amount. To reduce the bit rate, the background video image blocks within the background can be compressed at a higher level, thus reducing the bit rate by an appropriate amount so that the overall bit rate from the encoder is constant.

In a third embodiment of the invention, the encoder or encoders of multiple video sources which include multiple ROIs and background images are controlled by the means for classifying a video image to produce a fixed bit rate for all of the image streams. The background images will have their rates reduced by an appropriate amount to compensate for the increased bit-rates for the ROIs so that a fixed composite bit-rate is maintained.

In a fourth embodiment of the invention, the encoder is configured to produce an average output bit rate. Average bit rate encoders are useful for systems where the instantaneous bandwidth is not as important as an average bandwidth requirement. For an ROI, the encoding uses more bits for a higher quality image and thus has a higher bit rate. To compensate for the increased bit rate for the ROI, the average bit rate of the background video is reduced by an appropriate amount. To reduce the background bit rate, the compression of the background video image blocks is increased, thus reducing the background bit rate so that the overall average data rate from the encoder remains at a predetermined level.

In a further embodiment, the device that classifies an ROI generates metadata and alarms regarding at least one of the ROIs where the metadata and alarms reflect the classification and prioritization of a threat. For example, the metadata can show the path that a person took through the imager field-of-view. An alarm can identify a person moving into a restricted area or meeting specific predetermined behavioral characteristics such as tail-gating through a security door.

In another embodiment of the first aspect of the invention, the video capture apparatus includes a storage device configured to store one or more of; metadata, alerts, uncompressed digital video data, encoded (compressed) ROIs, and the encoded background video. The storage can be co-located with the imager or can be located away from the imager. The stored data can be stored for a period of time before and after an event. Further, the data can be sent to the storage device in real-time or later over a network to a Network Video Recorder.

In yet another embodiment, the apparatus includes a network module configured to receive encoded ROI data, encoded background video, metadata and alarms. Further, the network module can be coupled to a wide or local area network.

In a second aspect of the present invention, an apparatus for capturing a video image is disclosed where the captured video stream is broken into a data stream for each ROI and a background data stream. Further, the apparatus includes a device for the classification of the digital video into ROIs and background video. The classification of the ROIs is implemented as described above in the first aspect of the present invention. Also, the invention includes an apparatus or means for encoding the digital video image into an encoded data stream for each of the ROIs and the background image. Further, the invention includes an apparatus or means to control multiple aspects of the ROI stream generation. The resolution for each of the ROI streams can be individually increased or decreased. Increasing resolution of the ROI can allow zooming in the ROI while maintaining a quality image of the ROI. The frame rate of the ROI stream can be increased to better capture fast-moving action. The frame rate of the background stream can be decreased to save bandwidth or temporarily increased when improved monitoring is indicated.

In one embodiment of the invention, the apparatus or means for encoding a video stream compresses the ROI and the background streams. The compression for each of the ROI steams can be individually set to provide an image quality greater than the background image. As was discussed in the first aspect of the invention, the classification means that identifies the ROI use predictive techniques incorporating an ROI history can be implemented in a feedback loop where a previous digital video image or previous ROI track information are used to generate updated ROIs. The means for classifying the video image into one or more ROIs can determine an updated ROI position using predictive techniques based on the ROI history. The ROI history can include previous position and velocity predictions. The predictive techniques can compensate for the delay of one or more video frames between the new video image and the previous video image or ROI position prediction. The updated ROIs specify an updated size and position of the ROI and can additionally specify the frame rate and image resolution for the ROI.

In a further embodiment of the invention, an associated ROI priority is determined for each of the ROI streams by the means for classifying the video. This means can be a man-in-the-loop operator who selects the ROI, or an automated system where a device, such as a video analytics engine identifies and prioritizes each ROI. Based on the associated ROI priority, the ROIs are compressed such that the higher priority images have a higher image quality when decompressed. In one embodiment of the invention, the increased data rate used for the ROIs is balanced by using a higher compression on the background image, reducing the background bit rate, and thus providing a constant combined data rate. In another embodiment, the average ROIs bit rate increases due to compression of higher priority images at an increased image quality. To compensate, the background image is compressed at a greater level to provide a reduced average background data rate and thus balancing the increased average ROI bit rate.

In a further embodiment, the apparatus for capturing a video image includes a display device that decodes the ROI and background video streams where the decoded ROIs are merged with the background video image and output on a display device. In another embodiment, a second display device is included where one or more ROIs are displayed on one monitor and the background image is displayed on the other display device.

In another aspect of the present invention, an apparatus is capturing a video image. The apparatus includes an imager device for generating a digital video image. The digital video image can be generated directly from the imager or be a digital video image produced from an analog video stream and subsequently digitized. Further, the apparatus includes a device for the classification of the digital video image into ROIs and background. The classification of an ROI can be performed either manually by a human operator or automatically through computational video analytics algorithms. As discussed in the first aspect of the invention, an apparatus or means for encoding the digital video image is included. Also included are means for controlling the ROIs, both in image quality and in position by either controlling the pixels generated by the imager or by post processing of the image data. The ROI image quality can be improved by using more pixels in the ROI. This also can implement a zoom function on the ROI. Further, the frame rate of the ROI can be increased to improve the image quality of fast-moving targets.

The control also includes the ability to change the position of the ROI and the size of the ROI within the imager field-of-view. This control provides the ability to track a target within an ROI as it moves within the imager field-of-view. This control provides a pan and tilt capability for the ROI while still providing the background video image for viewing, though at a lower resolution and frame rate. The input for the controller can be either manual inputs from an operator interface device, such as a joystick, or automatically provided through a computational analysis device. In one embodiment of the invention, the apparatus further comprises an apparatus, device, or method of encoding the ROI streams and the background image stream. For each of these streams there can be an associated encoding compression rate. The compression rate is set so that the ROI streams have a higher image quality than the background image stream. In another embodiment of the invention, a feedback loop is formed by using a preceding digital video image or preceding ROI track determination to determine an updated ROI. The means for classifying the video image into one or more ROIs can determine an updated ROI position using predictive techniques based on the ROI history. The ROI history can include previous position and velocity predictions. The predictive techniques can compensate for the delay of one or more video frames between the new video image and the previous video image or ROI position prediction. In another embodiment, each ROI has an associated priority.

The priority is used to determine the level of compression to be used on each ROI. In an another embodiment, as discussed above, the background image compression level is configured to reduce the background bit rate by an amount commensurate to the increased data rate for the ROIs, thus resulting in a substantially constant bit rate for the combined ROI and background image streams. In a further embodiment, the compression levels are set to balance the average data rates of the ROI and background video.

In another embodiment, an apparatus device or method is provided for a human operator to control the ROI by either panning, tilting, or zooming the ROI. This control can be implemented through a joystick for positioning the ROI within the field-of-view of the camera and using a knob or slide switch to perform an image zoom function. A knob or slide switch can also be used to manually size the ROI.

In another embodiment, the apparatus includes a display device for decoding and displaying the streamed ROIs and the background image. The ROI streams are merged with the background image for display as a combined image. In a further embodiment, a second display device is provided. The first display device displays the ROIs and the second display device displays the background video image. If the imager produces data at a higher resolution or frame rate, the ROIs can be displayed on the display device at the higher resolution and frame rate. On the second display device, the background image can be displayed at a lower resolution, frame rate, and clarity by using to a higher compression level.

A third aspect of the present invention is for an apparatus for capturing a video image. As described above, the apparatus includes a means for generating a digital video image, a means for classifying the digital video image into one or more ROIs and a background video image, and a means for encoding the digital video image into encoded ROIs and an encoded background video. Additionally, the apparatus includes a means for controlling the ROIs display image quality by controlling one or more of the compression levels for the ROI, the compression of the background image, the image resolution of the ROIs, the image resolution of the background image, the frame rate of the ROIs, and the frame rate of the background image. In an embodiment of the present invention, a feedback loop is formed by using at least one of a preceding digital image or a preceding ROI position prediction to determine updated ROIs. The means for classifying the video image into one or more ROIs can determine an updated ROI position using predictive techniques based on the ROI history. The ROI history can include previous position and velocity predictions. The predictive techniques can compensate for the delay of one or more video frames between the new video image and the previous video image or ROI position prediction. In a further embodiment, means for classifying the digital video image also determines the control parameters for the means of controlling the display image quality.

A fourth aspect of the present invention is for an apparatus for capturing a video image. The apparatus comprises a means for generating a digital video image having configurable image acquisition parameters. Further, the apparatus has a means for classifying the digital video image into ROIs and a background video image. Each ROI has an image characteristic such as brightness, contrast, and dynamic range. The apparatus includes a means of controlling the image acquisition parameters where the control is based on the ROI image characteristics and not the aggregate image characteristics. Thus, the ability to track and observe targets within the ROI is improved. In one embodiment, the controllable image acquisition parameters include at least one of image brightness, contrast, shutter speed, automatic gain control, integration time, white balance, anti-bloom, and chromatic bias. In another embodiment of the invention, the image acquisition parameters are controlled to maximize the dynamic range of at least one of the ROIs.

### BRIEF DESCRIPTION OF THE DRAWINGS

The invention is better understood by reading the following detailed description of an exemplary embodiment in conjunction with the accompanying drawings.

FIG. 1 illustrates one apparatus embodiment for capturing a video image.

FIG. 2 illustrates an apparatus embodiment for capturing a video image with multiple sensor head capture devices.

FIG. 3A illustrates a video image where all of the images are encoded at that same high compression rate.

FIG. 3B illustrates a video image where two regions of interest are encoded at a higher data rate producing enhanced ROI video images.

FIG. 4 illustrates two display devices, one displaying the background image with a high compression level and the second monitor displaying two ROIs.

### DETAILED DESCRIPTION OF THE INVENTION

The following description of the invention is provided as an enabling teaching of the invention in its best, currently known embodiment. Those skilled in the relevant art will recognize that many changes can be made to the embodiment described, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptions to the present inventions are possible and may even be desirable in certain circumstances, and are a part of the present invention. Thus, the following description is provided as illustrative of the principles of the present invention and not in limitation thereof, since the scope of the present invention is defined by the claims.

The illustrative embodiments of the invention provide a number of advances over the current state-of-the-art for the wide area surveillance. These advances in the state-of-the-art include camera specific advances, intelligent encoder and camera specific advances, and in the area of intelligent video analytics.

The illustrative embodiments of the invention provide the means for one imager to simultaneously perform wide area surveillance and detailed target interrogation. The benefits of such dual mode operations are numerous. A low resolution mode can be employed for wide angle coverage sufficient for accurate detection and a high resolution mode for interrogation with sufficient resolution for accurate classification and tracking. Alternatively, a high resolution region of interest (ROI) can be sequentially scanned throughout the wide area coverage to provide a momentary but high performance detection scan, not unlike an operator scanning the perimeter with binoculars.

High resolution data is provided only in specific regions where more information is indicated by either an operator or through automated processing algorithms that characterize an area within the field-of-view as being an ROI. Therefore, the imager and video analysis processing requirements are greatly reduced. The whole scene does not need to be read out and transmitted to the processor in the highest resolution. Thus, the video processor has much less data to process.

Furthermore, the bandwidth requirements of the infrastructure supporting the illustrative embodiments of the invention are reduced. High resolution data is provided for specific regions of interest within the entire scene. The high resolution region of interest can be superimposed upon the entire scene and background which can be of much lower resolution. Thus, the amount of data to be stored or transferred over the network is greatly reduced.

A further advantage of the invention is that the need to bore sight a fixed camera and a PTZ camera is eliminated. This eliminates complexities and performance deficiencies introduced by unstable channel to channel alignment such as caused by look up table corrections LUTs and imaging displacement due to parallax.

Another advantage of the current invention is the ability of the imager to implement a pan and tilt operation without requiring a gimbal or other moving parts.

Specifically the benefits of this capability are:
1. The camera will view the same background since there is no motion profile, thereby relaxing computational requirements on automated background characterization.
2. Target detection, classification and tracking will be improved since the inventions embodiment does not require time to settle down and stabilize high magnification images following a mechanical movement.
3. Components such as gimbals, position encoders, drive motors, motor power supplies and all components necessary for motion control and actuation are eliminated. Thus, the reduction of parts and elimination of moving mechanical parts will result in a higher MTBF.
4. A much smaller form factor can be realized because there are no moving parts such as gimbals are required, or their support accessories such as motion control electronics, power supplies, etc.
5. A lower cost to produce can be realized due to the reduction of complexity of components and associated assembly time.

Intelligent Encoder: Another inventive aspect of the invention is the introducing of video analytics to the control of the encoding of the video. The incorporation of video analytics offers advantages and improves the utility over a current state-of-the-art surveillance system. Intelligent video algorithms continuously monitor a wide area for new targets, and track and classify such targets. Simultaneously, the illustrative embodiments of the invention provide for detailed investigation of multiple targets with higher resolution and higher frame rates than standard video, without compromising wide area coverage. Blind spots are eliminated and the total situational awareness achieved is unprecedented. A single operator can now be fully apprised of multiple targets, of a variety of classifications, forming and fading, moving and stationary, and be alerted to breeches of policy or threatening behavior represented by the presence, movement and interaction of targets within the entire field-of-view.

Placing the analytics within proximity to the video source, thereby eliminating transmission quality and quantity restrictions, enables a higher accuracy analytics by virtue of higher quality video input and reduced latency. This will be realized as improved detection, improved classification, and improved tracking performance.

Further improvements can be realized through intimate communication between video analytics and imager control. By enabling the analytics to define a priority to ROIs, targets can be imaged at better resolution by reducing the resolution at lower priority regions. This produces higher quality data for analytics. Furthermore, prioritizing regions makes possible more efficient application of processing resources. For example, high resolution imagery can be used for target classification, lower resolution imagery for target tracking, and lower still resolution for background characterization.

Placement of analytics at the video source, and before transmission, makes possible intelligent video encoding and transmission. For example, video can be transmitted using conventional compression techniques where the bit rate is prescribed. Alternatively, the video can be decomposed into regions, where only the regions are transmitted, and each region can use a unique compression rate based on priority of video content within the region. Finally, the transmitted video data rate can be a combination of the previous two modes, so that the entire frame is composed of a mosaic of regions, potentially each of unique priority and compression.

These techniques will result in a more efficient network bandwidth utilization, a more accurate analytics, and an improved video presentation since priority regions are high fidelity. Further, systems such as license plate recognition, face recognition, etc. residing at back end that consume decoded video will benefit from high resolution data of important targets.

Another advantage of the invention over the current processing is that it places the video processing at the edge of the network. The inherent advantages of placing analytics at the network edge, such as in the camera or near the camera are numerous and compelling. Analytic algorithmic accuracy will improve given that high fidelity (raw) video data will be feeding algorithms. Scalability is also improved since cumbersome servers are not required at the back end. Finally total cost of ownership will be improved through elimination of the capital expense of the servers, expensive environments in which to house them and recurring software operation costs to sustain them.

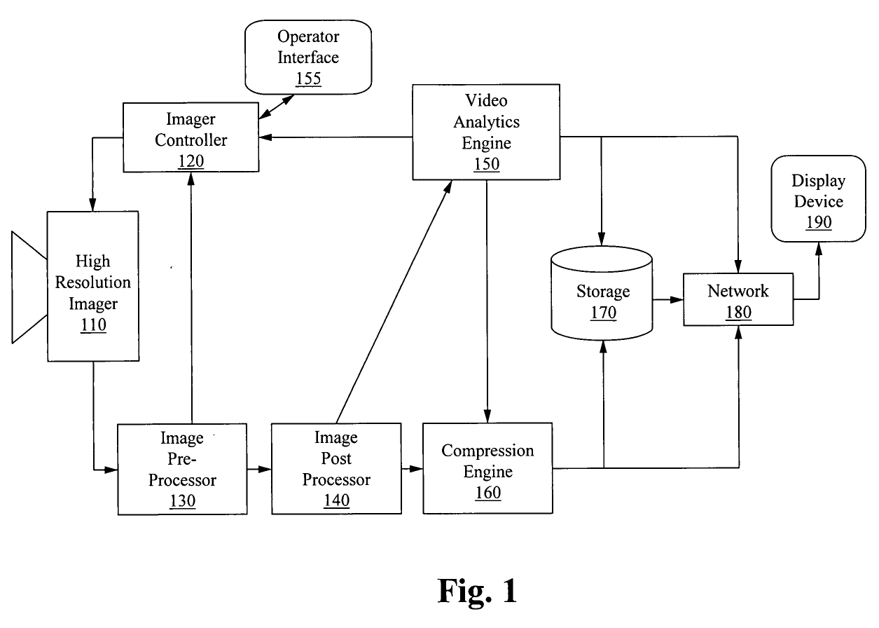

An illustrative embodiment of the present invention is shown in FIG. 1. The apparatus for capturing and displaying an image includes of a high resolution imager 110. The image data generated by the imager 110 is processed by an image pre-processor 130 and an image post-processor 140. The pre and post processing transforms the data to optimize the quality of the data being generated by the high resolution imager 110, optimizes the performance of the video analytics engine 150, and enhances the image for viewing on a display device 155, 190. Either the video analytics engine 150 or an operator interface 155 provide input to control an imager controller 120 to define regions of interest (ROI), frame rates, and imaging resolution. The imager controller 120 provides control attributes for the image acquisition, the resolution of image data for the ROI, and the frame rate of the ROIs and background video images. A feedback loop is formed where the new image data from the imager 110 is processed by the pre-processor 130 and post-processor 140 and the video analytics engine determines an updated ROI. The means for classifying the video image into one or more ROIs can determine the position of the next ROI using predictive techniques based on the RIO position prediction history. ROI position prediction history can include position and velocity information. The predictive techniques can compensate for the delay of one or more video frames between the new video image and the previous video image or ROI position history.

The compression engine 160 receives the image data and is controlled by the video analytics engine 150 as to the level of compression to be used on the different ROIs. The ROIs are compressed less than the background video image. The video analytics engine also generates metadata and alarms. This data can be sent to storage 170 or out through the network module 180 and over the network where the data can be further processed and displayed on a display device 190.

The compression engine 160 outputs compressed data that can be saved on a storage device 170 and can be output to a network module 180. The compressed image data, ROI and background video images, can be decoded and displayed on a display device 190. Further details are provided of each of the components of the image capture and display apparatus in the following paragraphs.

Conditioned light of any potential wavelength from the optical lens assembly is coupled as an input to the high resolution imager 110. The imager 110 outputs images that are derived from digital values corresponding to the incident flux per pixel. The pixel address and pixel value is coupled to pre-processor.

The imager 110 is preferable a direct-access type, such that each pixel is individually addressable at each frame interval. Each imaging element accumulates charge that is digitized by a dedicated analog-to-digital converter (ADC) located within proximity to the sensor, ideally on the same substrate. Duration of charge accumulation (integration time), spectral responsivity (if controllable), ADC gain and DC offset, pixel refresh rate (frame rate for pixel), and all other fundamental parameters that are useful to digital image formation are implemented in the imager 110, as directed by the imager controller 120. It is possible that some pixels are not forwarded any data for a given frame.

The imager 110 preferably has a high spatial resolution (multi-megapixel) and has photodetectors that are sensitive to visible, near IR, midwave IR, longwave IR and other wavelengths, but not limited to wavelengths employed in surveillance activities. Furthermore, the preferred imager 110 is sensitive to a broad spectrum, has a controllable spectral sensitivity, and reports spectral data with image data thereby facilitating hyperspectral imaging, detection, classification, and discrimination.

The data output of the imager 110 is coupled output to an image pre-processor 130. The image pre-processor 130 is coupled to receive raw video in form of frames or streams from the imager 110. The pre-processor 130 outputs measurements of image quality and characteristics that are used to derive imaging adjustments of optimization variables that are coupled to the imager controller 120. The pre-processor 130 can also output raw video frames passed through unaltered to the post-processor 140. For example, ROIs can be transmitted as raw video data.

The image post-processor 140 optimizes the image data for compression and optimal video analytics. The post-processor 140 takes is coupled to receive raw video frames or ROIs from the pre-processor 130, and outputs processed video frames or ROIs to a video analytics engine 150 and a compression engine 160, or a local storage device 170, or a network module 180. The post-processor 140 controls for making adjustments to incoming digital video data including but not limited to: image sizing, sub sampling of captured digitized image to reduce its size, interpolation of sub-sampled frames and ROIs to produce large size images, extrapolation of frames and ROIs for digital magnification (empty magnification), image manipulation, image cropping, image rotation, and image normalization.

The post-processor 140 can also apply filters and other processes to the video including but not limited to, histogram equalization, unsharp masking, highpass/lowpass filtering, and pixel binning.

The imager controller 120 receives information from the image pre-processor 130, and either an operator interface 155 and or from the video analytics engine 150. The function of the imager controller 120 is to activate only those pixels that are to be read off the imager 110 and to actuate all of the image optimization parameters resident on the imager 110 so that each pixel and/or region of pixels is of substantially optimal image quality. The output of the imager controller 120 is control signals output to the imager 110 that actuates the ROI size, shape, location, ROI frame rate, pixel sampling and image optimization values. Further, it is contemplated that the ROI could be any group of pixels associated with an object in motion or being monitored.

The imager controller 120 is coupled to receive optimization parameters from the pre-processor 130 to be implemented at imager 110 for next scheduled ROI frame for the purposes of image optimization. These parameters can include but are not limited to: brightness and contrast, ADC gain & offset, electronic shutter speed, integration time, y amplitude compression, an white balance. These acquisition parameters are also output to the imager 110.

Raw digital video data for each active pixel on the imager 110, along with its membership status in an ROI or ROIs, is passed to the imager controller 120. The imager controller 120 extracts key ROI imaging data quality measurements, and computes the optimal imaging parameter setting for the next frame based on real-time and historical data. For example, an ROI can have an overexposed area (hotspot) and a blurred target. For example, a hotspot can be caused by headlights of an oncoming automobile overstimulating a portion of the imager 110. The imager controller 120 is adapted to make decisions on at least integration time, amplitude compression, anticipated hotspot probability on next frame to suppress the hot spot. Furthermore, the imager controller 120 can increase frame rate and decrease the integration time below that which is naturally required by frame rate increase to better resolve the target. These image formation optimization parameters, associated with each ROI, are coupled to the imager 110 for imager configuration.

The imager controller 120 is also coupled to receive the number, size, shape and location of ROIs for which video data is to be collected. This ROI data can originate from either a manual input such as a joy stick, mouse, etc. or automatically from video or other sensor analytics.

For manual operation such as, digital pan and tilt manual mode from an operator interface 155, control inputs define an ROI initial size and location manually. The ROI is moved about within the field-of-view by means of further operator inputs though the operator interface 155 such as a mouse, joystick or other similar man-in-the-loop input device. This capability shall be possible on real-time or recorded video, and gives the operator the ability to optimize pre and post processing parameters on live images, or post processing parameters on recorded video, to better detect, classify, track, discriminate and verify targets manually. This mode of operation provides similiar functionality as a traditional Pan Tilt Zoom PTZ actuation. However, in this case there are no moving parts, the ROIs are optimized at the expense of the surrounding scene video quality.

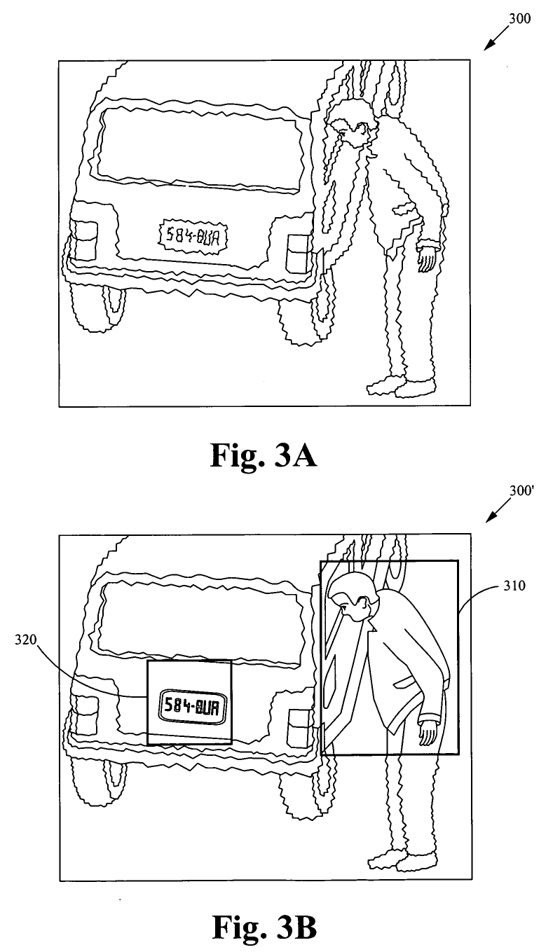

Alternatively, the determination of the ROI can originate from the video analytics engine 150 utilizing intelligent video algorithms and video understanding system that define what ROIs are to be imaged for each frame. This ROI can be every pixel in the imager 110 for a complete field-of-view, a subset (ROI) of any size, location and shape, or multiple ROIs. For example ROI₁ can be the whole field-of-view, ROI₂ can be a 16×16 pixel region centered in the field-of-view, and ROI₃ can be an irregular blob shape that defies geometrical definition, but that matches the contour of a target, with a center at +22, −133 pixels off center. Examples of the ROIs are illustrated in FIG. 3B where a person 210 is one ROI and a license plate 220 is another ROI.

Furthermore, the imager controller 120 is coupled to receive the desired frame rate for each ROI, which can be unique to each specific ROI. The intelligent video algorithms and video understanding system of the video analytics engine 150 will determine the refresh rate, or frame rate, for each of the ROIs defined. The refresh rate will be a function of ROI priority, track dynamics, anticipated occlusions and other data intrinsic to the video. For example, the entire background ROI can be refreshed once every 10 standard video frames, or at 3 frames/second. A moderately ranked target ROI with a slow-moving target may be read at standard frame rate, or 10 frames per second, and a very high priority and very fast moving target can be refreshed at three times the standard frame rate, or 30 frames per second. Other refreshed times are also contemplated. Frames rates per ROI are not established for the life of the track, but rather as frequent as necessary as determined by the video analytics engine 150.

Also, the imager controller 120 can take as an input the desired sampling ratio within the ROI. For example, every pixel within the ROI can be read out, or a periodic subsampling, or a more complex sampling as can be derived from an algorithmic image processing function. The imager controller 120 can collect pixel data not from every pixel within ROI, but in accordance with a spatially periodic pattern (e.g. every other pixel, every fourth pixel). Subsampling need not be the same in x and y directions, nor necessarily the same pattern throughout the ROI (e.g. pattern may vary with location of objects within ROI).

The imager controller 120 also controls the zooming into an ROI. When a subsampled image is the initial video acquisition condition, digital-zoom is actuated by increasing the number of active pixels contributing to the image formation. For example, an image that was originally composed from a 1:4 subsampling (every fourth pixel is active) can be zoomed in, without loss of resolution, by subsampling at 1:2. This technique can be extended without loss of resolution up to 1:1, or no subsampling. Beyond that point, further zoom can be achieved by extrapolating between pixels in a 2:1 fashion (two image pixels from one active pixel). Pixels can be grouped together to implement subsampling, for example a 4×4 pixel region can be averaged and treated as a single pixel. The advantage of this approach to subsampling is a boon in signal responsivity proportional to the number of active pixels that contribute to a singular and ultimate pixel value.

The video analytics engine 150 classifies ROIs within the video content, according to criteria established by algorithms or by user-defined rules. The classification includes the identification, behavioral attribute identification, and tracking. Initial ROI identification can be performed manually through an operator interface 155 wherein the tracking of an object of interest within the ROI is performed by the video analytics engine 150. Further, the video analytics module 150 can generate alerts and alarms based on the video content. Furthermore, the analytics module 150 will define the acquisition characteristics for each ROI number and characteristics for next frame, frame rate for each ROI, and sampling rate for each ROI.

The video analytics module 150 is coupled to receive, video in frame or ROI stream format from the imager 110 directly, the pre-processor 130, or the post-processor 140. The video analytics engine 150 outputs include low level metadata, such as target detection, classification, and tracking data and high level metadata that describes target behavior, interaction and intent.

The analytics engine 150 can prioritize the processing of frames and ROIs as a function of what behaviors are active, target characteristics and dynamics, processor management and other factors. This prioritization can be used to determine the level of compression used by the compression engine 160. Further, the video analytics engine 150 can determine a balance between the compression level for the ROIs and the compression level for the background image based on the ROIs characteristics to maintain a constant combined data rate or average data rate. This control information is sent to the compression engine 160 and the imager controller 120 to control parameters such as ROI image resolution and the frame rate. Also contemplated by this invention is the video analytics engine 150 classifying video image data from more than one imager 110 and further controlling one or more compression engine 160 to provide a bit-rate for all of the background images and ROIs that is constant.

The compression engine 160 is an encoder that selectively performs lossless or lossy compression on a digital video stream. The video compression engine 160 takes as input video from either the image pre-processor 130 or image post-processor 140, and outputs digital video in either compressed or uncompressed format to the video analytics engine 150, the local storage 170, and the network module 180 for network transmission. The compression engine 160 is adapted to implement compression in a variety of standards not limited to H.264, MJPEG, and MPEG4, and at varying levels of compression. The type and level of compression will be defined by video analytics engine 150 and can be unique to each frame, or each ROI within a frame. The output of the compression engine 160 can be a single stream containing both the encoded ROIs and encoded background data. Also, the encoded ROIs and encoded background video can be transmitted separate streams.

The compression engine 160 can also embed data into compressed video for subsequent decoding. This data can include but is not limited to digital watermarks for security and non-repudiation, analytical metadata (video stenography to include target and tracking symbology) and other associated data (e.g. from other sensors and systems).

The local storage device 170 can take as input compressed and uncompressed video from the compression engine 160, the imager 110 or any module between the two. Data stored can but need not include embedded data such as analytic metadata and alarms. The local storage device 170 will output all stored data to either a network module 180 for export, to the video analytic engine 150 for local processing or to a display device 190 for viewing. The storage device 170 can store data for a period of time before and after an event detected by the video analytics engine 150. A display device 190 can be provided pre and post viewing of an event from stored data. This data can be transferred through the network module 180 either in real-time or later to a Network Video Recorder or display device.

The network module 180 will take as input compressed and uncompressed video from compression engine 160, raw video from the imager 110, video of any format from any device between the two, metadata, alarms, or any combination thereof. Video and data exported via the network module 180 can include compressed and uncompressed video, with or without video analytic symbology and other embedded data, metadata (e.g. XML), alarms, and device specific data (e.g. device health and status).

The display device 190 displays video data from the monitoring system. The data can be compressed or uncompressed ROI data and background image data received over a network. The display device decodes the streams of imagery data for display on one or more display devices 190 (second display device not show). The image data can be data received as a single stream or as multiple streams. Where the ROI and background imagery is sent as multiple streams, the display device can combine the decoded streams to display a single video image. Also, contemplated by the current invention is the use of a second display device (not shown). The ROIs can be displayed on the second monitor. If the ROIs were captured at an enhanced resolution and frame rate as compared to the background video, then the ROIs can be displayed an enhanced resolution and a faster frame rate.

Contemplated within the scope of the invention, integration of elements can take on different levels of integration. All of the elements can be integrated together, separate or in any combination. One specific embodiment contemplated is the imager 110, image controller 120, and the pre-processor 130 integrated into a sensor head package. The post-processor 140, video analytics engine 150, compression engine 160, storage 170 and network module 180 integrated into an encoder package. The encoder package can be configured to communicate with multiple sensor head packages.

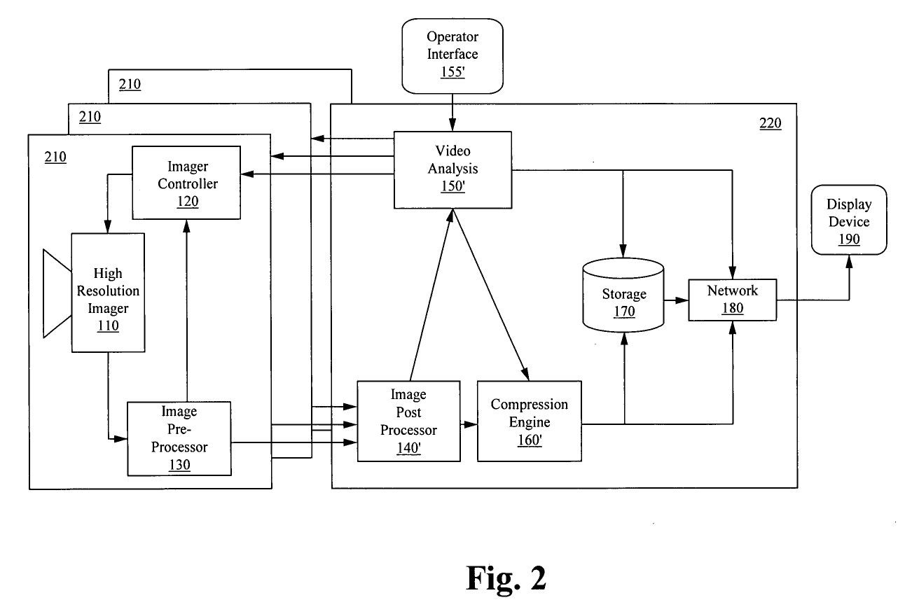

Another illustrative embodiment of the present invention is shown in FIG. 2. In this embodiment, the imager 110, imager controller 120, and pre-processor 130 are configured into an integrated sensor head unit 210. The video analytics engine 150, post-processor 140, compression engine 160, storage 170, and network module 180 are configured as a separate integrated unit 220. The elements of the sensor head 210 operate as described above in FIG. 1. The video analytics engine 150′ operates as described above in FIG. 1 except that it classifies ROIs from multiple image streams from each sensor head 210 and generates ROI predictions for multiple camera control. Further, the video analytics engine 150′ can determine ROI priority across multiple image streams and control the compression engine 160′ to obtain a selected composite bit rate for all of the ROIs and background images to be transmitted.

FIG. 3A is illustrative of a video image capture system where the entire video image is transmitted at the same high compression level that is often selected to save transmission bandwidth and storage space. FIG. 3A illustrates that while objects within the picture, particularly the car, license plate, and person are easily recognizable, distinguishing features are not ascertainable. The licence plate is not readable and the person is not identifiable. FIG. 3B illustrates a snapshot of the video image where the video analytics engine (FIG. 1, 150) has identified the license plate 320 and the person 310 as regions of interest and has configured the compression engine (FIG. 1, 160) to compress the video image blocks containing the license plate region 320 and the top part of the person 310 with less information loss. Further, the video analytics engine (FIG. 1, 150) can configure the imager (FIG. 1, 110) to change the resolution and frame rate of the license plate ROI 320 and the person ROI 310. The video image, as shown in FIG. 3B can be transmitted to the display device (FIG. 1, 190) as a single stream where the ROIs, 310 and 320, are encoded at an enhanced image quality, or as multiple streams where, the background image 300 and the ROI streams for the license plate 320 and person 310 are recombined for display.

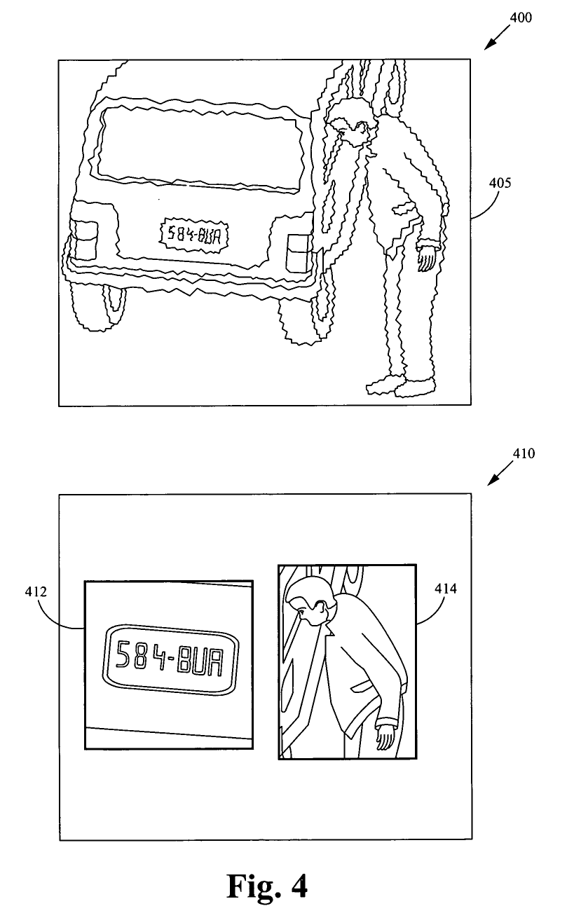

FIG. 4 illustrates a system with two display devices 400 and 410. This configuration is optimal for systems where the ROIs and background are transmitted as separate streams. On the first display device 400 the background video image 405 is displayed. This view provides an operator a complete field-of-view of an area. On the second display device 410, one or more regions of interest are displayed. As shown, the license plate 412 and person 414 are shown at an enhanced resolution and at a compression level with less information loss.

An illustrative example of the operation of a manually operated and automated video capture system is provided. These operational examples are only provided for illustrative purposes and are not intended to limit the scope of the invention.

In operation, one embodiment of the invention comprises a manually operated (man-in-the-loop) advanced surveillance camera that provides for numerous benefits over existing art in areas of performance, cost, size and reliability.

The illustrative embodiments of the invention comprise a direct-access imager (FIG. 1, 110) of any spectral sensitivity and preferably of high spatial resolution (e.g. multi-megapixel), a control module 120 to effect operation of imager 110, and a pre-processor module 130 to condition and optimize the video for viewing. The illustrative embodiments of the invention provide the means to effect pan, tilt and zoom operations in the digital domain without any mechanical or moving parts as required by current state of art.

The operator can either select through an operator interface 155 a viewing ROI size and location (via a joystick, mouse, touch screen or other human interface), or an ROI can be automatically initialized. The ROI size and location are input to the imager controller 120 so that the imaging elements and electronics that correspond to the ROI viewing area are configured to transmit video signals. Video signals from the imager 110 for pixels within the ROI and are given a priority, and can in some instances be the only pixels read off the imager 110. The video signals are then sent from the imager 110 to the pre-processor 130 where the video image is manipulated (cropped, rotated, shifted . . . ) and optimized according to camera imaging parameters specifically for the ROI rather than striking a balance across the whole imager 110 field-of-view. This particularly avoids losing ROI clarity in the case of hot spots and the like. The conditioned and optimized video is then coupled for either display (155 or 190), storage 170, or to further processing (pre-processor 140 and post-processor 160) or any combination thereof.

Once the ROI size is defined the operator can actuate digital pan and tilt operations, for example by controlling a joystick, to move the ROI within the limits of the entire field-of-view. The resultant ROI location will be digitally generated and fed to the imager 110 so that the video read off the imager 110 and coupled to the display monitor, reflects the ROI position, both during the movement of the ROI and when the ROI position is static.

Zoom operations in the manual mode are realized digitally by control of pixel sampling by the imager 110. In current art, digital zoom is realized by coupling the contents of an ROI to more display pixels than originally were used to compose the image and interpolating between source pixels to render a viewable image. While this does present a larger picture for viewing, it does not present more information to the viewer, and hence is often referred to as “empty magnification.”

The illustrative embodiments of the invention take advantage of High Definition (HD) imagers to provide a true digital zoom that presents the viewer with a legitimately zoomed (or magnified) image entirely consistent with an optical zoom as traditionally realized through a motorized telephoto optical lens assembly. This zoom capability is achieved by presenting the viewer with a wide area view that is constructed by sub-sampling the imagers. For example, every fourth pixel in X row and Y column within the ROI is read out for display. The operator can then zoom in on a particular region of the ROI by sending appropriate inputs to the imager controller 120. The controller 120 then instantiates an ROI in X and Y accordingly, and will also adjust the degree of subsampling. For example, the subsampling can decrease from 4:1 to 3:1 to 2:1 and end on 1:1 to provide a continuous zoom to the limits of the imager and imaging system. In this case, upon completion of the improved digital zoom operation, the operator is presented with an image four times magnified and without loss of resolution. This is equivalent to a 4× optical zoom in terms of image resolution and fidelity. The illustrative embodiments of the invention provides for additional zoom beyond this via conventional empty magnification digital zoom prevalent in the current art.

The functionality described in the manual mode of operation can be augmented by introducing an intelligent video analytics engine 150 that consists of all the hardware, processor, software, algorithms and other components necessary for the implementation. The analytics engine 150 will process video stream information to produce control signals for the ROI size and location and digital zoom that is sent to the imager controller 120. For example, the analytics engine 150 may automatically surveil a wide area, detect a target at great distance, direct the controller 120 to instantiate an ROI around the target, and digitally zoom in on the target to fill the ROI with the target profile and double the video frame rate. This will greatly improve the ability of the analytics to subsequently classify, track and understand the behavior of the target given the improved spatial resolution and data refresh rates. Furthermore, this interrogation operation can be conducted entirely in parallel, and without compromising, a continued wide area surveillance. Finally, multiple target interrogations and tracks can be simultaneously instantiated and sustained by the analytics engine 150 while concurrently maintaining a wide area surveillance to support detection of new threats and provide context for target interaction.

What is claimed is:

1. An apparatus for capturing a video image comprising:
a. means for generating a digital video image;
b. means for classifying the digital video image into one or more regions of interest (ROI) and a background image; and
c. means for encoding the digital video image, wherein the encoding is selected to provide at least one of, enhancement of the image clarity of the one or more ROI relative to the background image encoding, and decreasing the clarity of the background image relative to the one or more ROI.

2. The apparatus of claim 1, further comprising a feedback loop formed by the means for classifying the digital video image using at least one of a preceding digital video image and a preceding ROI position prediction, to determine the one or more ROI, wherein the preceding digital video image is delayed by one or more video frames.

3. The apparatus of claim 2, further comprising an associated ROI priority, wherein the means for classifying the digital video image determines the associated ROI priority of the one or more ROI, and wherein one or more levels of encoding are set for each ROI according to the associated ROI priority.

4. The apparatus of claim 3, wherein the means for encoding the digital video image produces a fixed encoding bit rate comprising a background image bit rate and one or more ROI bit rates, and wherein the background bit rate is reduced in proportion to the increase in the one or more ROI bit-rates, thereby maintaining the fixed encoding bit rate while an enhanced encoded one or more ROI is generated.

5. The apparatus of claim 3, wherein the means for encoding the digital video image produces a fixed encoding bit rate comprised of a background image bit rate and one or more ROI bit rates, and wherein the means for classifying a video image processes images from a plurality of means for generating a digital video image, and wherein the means for classifying the digital video image controls the ROI bit-rates and background image bit rates from each means for generating the digital video image, wherein the background image bit rates are reduced in proportion to the increase in the ROI bit-rates, thereby maintaining the fixed encoding bit rate for all the ROIs and background images.

6. The apparatus of claim 3, wherein the means for encoding the digital video image produces an average encoding bit rate comprised of an average background image bit rate, and one or more average ROI bit rates, and wherein the average background bit rate is reduced in proportion to the increase in the one or more average ROI bit-rates to maintain the average encoding bit rate.

7. The apparatus of claim 3, wherein the encoding is H.264.

8. The apparatus of claim 3, wherein the means for classifying a digital video image generates metadata and alarms regarding the one or more ROI.

9. The apparatus of claim 8, further comprising a storage device configured to store at least one of the metadata, the alarms, the one or more encoded ROI, and the encoded background image.

10. The apparatus of claim 8, further comprising a network module, wherein the networking module is configured to transmit to a network at least one of, the metadata, the one or more alerts, the one or more encoded ROI, and the encoded background image data.

11. An apparatus for capturing a video image comprising:
a. means for generating a digital video image;
b. means for classifying the digital video image into one or more regions of interest (ROI) and a background image;
c. means for generating one or more ROI streams and a background image stream; and
d. means for controlling at least one of, one or more ROI stream resolutions, one or more ROI positions, one or more ROI geometries, one or more ROI stream frame rates, and a background image stream frame rate based on the classification of the one or more ROI, thereby controlling the image quality of the one or more ROI streams and implementing Pan Tilt and Zoom imaging capabilities.

12. The apparatus in claim 11, further comprising: means for encoding the one or more ROI streams and encoding the background image stream, the means for encoding having an associated encoding compression rate, wherein the associated encoding compression rate for each of the one or more ROI streams is less than the encoding compression rate for the background image stream, thereby producing an encoded one or more ROI with an improved image quality.

13. The apparatus of claim 12, further comprising a feedback loop formed by the means for classifying the digital video image using at least one of a preceding digital video image and a preceding ROI position prediction, to determine the one or more ROI, wherein the preceding digital video image is delayed by one or more video frames.

14. The apparatus of claim 13, further comprising an associated ROI priority, wherein the means for classifying the digital video image determines the associated ROI priority of the one or more ROI streams, and wherein one or more levels of encoding compression for the one or more ROI streams are set according to the associated ROI priority.

15. The apparatus of claim 13, wherein the means for encoding produces a fixed encoding bit rate comprised of one or more ROI stream bit rates and a background image bit rate, wherein the one or more ROI bit rates are increased according to the associated ROI priority and the background bit rate is reduced in proportion, thereby maintaining the fixed encoding bit rate while the enhanced encoded one or more ROI are generated.

16. The apparatus of claim 14, wherein the means for encoding produces an average encoding bit rate comprised of one or more ROI stream average bit-rates and a background image average bit rate, wherein the one or more ROI average bit rates are increased according to the associated ROI priority and the background average bit rate is reduced in proportion, thereby maintaining the average encoding bit rate while the enhanced encoded one or more ROI are generated.

17. The apparatus of claim 14 further comprising a means for human interaction, wherein the means for human interaction implements at least one of the Pan Tilt and Zoom functions through coupling with the means for controlling at least one of, the one or more ROI resolution, the one or more ROI positions, and one or more ROI geometries.

18. The apparatus of claim 14, further comprising a display device that decodes and displays the one or more ROI streams and background image stream, wherein the one or more ROI streams are merged with the background image stream and displayed on the monitor, wherein the display device is configured with a means to select the ROI that an operator has classified as an ROI.

19. The apparatus of claim 14, further comprising a first and a second display device, wherein at least one of the one or more ROI are displayed on the first display device and the background image is displayed on the second display device.

20. An apparatus for capturing and displaying a video image comprising:
a. means for generating a digital video image;
b. means for classifying the digital video image into one or more regions of interest (ROI) and a background image;
c. means for encoding the digital video image, wherein the encoding produces one or more encoded ROI and an encoded background image; and
d. means for controlling a display image quality of one or more ROI by controlling at least one of, the encoding of the one or more encoded ROI, the encoding of the encoded background image, an image resolution of the one or more ROI, an image resolution of the background image, a frame rate of one or more ROI, and a frame rate of the background image.

21. The apparatus of claim 20, further comprising a feedback loop formed by the means for classifying the digital video image using at least one of a preceding digital video image and a preceding ROI position prediction, to determine the one or more ROI, wherein the preceding digital video image is delayed by one or more video frames.

22. The apparatus of claim 20, wherein the means for classifying the digital video image determines control parameters for the means of controlling the display image quality.

23. An apparatus for capturing a video image comprising:
a. means for generating a digital video image having one or more configurable image acquisition parameters;
b. means for classifying the digital video image into one or more regions of interest (ROI) and a background image, wherein the one or more regions of interest have an associated one or more ROI image characteristics; and
c. means for controlling at least one of the image acquisition parameters based on at least one of the associated one or more ROI image characteristics, thereby improving the image quality of at least one of the one or more ROI.

24. The apparatus of claim 23, wherein the image acquisition parameters comprises at least one of brightness, contrast, shutter speed, automatic gain control, integration time, white balance, anti-bloom, and chromatic bias.

25. The apparatus of claim 24, wherein each of the one or more ROI have an associated dynamic range, and wherein the means for controlling the one or more image acquisition parameters maximizes the dynamic range of at least one of the one or more ROI.
